(19) United States
(12) Patent Application Publication
(10) Pub. No.: US 2012/0186114 A1
(43) Pub. Date: Jul. 26, 2012

(54) Artists' water color paper stretcher and holder

(76) Inventor: David Bruce Boggs, (US)

(21) Appl. No.: 13/011,865

(22) Filed: Jan. 22, 2011

(51) Int. Cl. B44D 3/18

(52) U.S. Cl. 38/102.2

(57) ABSTRACT

The invention is a watercolor paper stretcher and holder device that holds watercolor paper taut against a board by means of strips of channel edging that are slid onto the edges of the board that is overlain with a piece of wet watercolor paper wrapped around the board edges and onto the board back. Friction of the channel edging strips against the paper and the wrapping of the paper around the board keep the paper from buckling and moving during initial drying on the board and during rewetting with aqueous media in the process of painting.

### CROSS-REFERENCE TO RELATED APPLICATIONS

Not applicable.

### STATEMENT REGARDING FEDERALLY SPONSORED RESEARCH OR DEVELOPMENT

Not applicable.

REFERENCE TO A SEQUENCE LISTING, A TABLE, OR A COMPUTER

### PROGRAM LISTING COMPACT DISC APPENDIX

Not applicable.

### BACKGROUND OF THE INVENTION

Before being painted upon in the execution of a watercolor painting, watercolor paper must be made taut and flat. It must then be maintained taut during the painting process so that watercolor or other media when applied do not act to buckle or wrinkle the paper, causing difficulty in executing the painting. The common methods used for preparing and maintaining taut and flat watercolor paper for painting involve soaking watercolor paper until the fibers are saturated, then placing the wet paper onto a board of length and width larger than those of the paper and securing the paper to the board by means of adhesion or mechanical fasteners, allowing the paper to dry or painting upon it while damp, then executing the painting by applying water, paints or other aqueous media onto the taut, flat paper. After the painting process is completed, the paper is removed from the board. Typical adhesion of the paper to the board is by way of gummed tape; typical mechanical fasteners are staples driven through the paper into the board, or metal or other materials placed against the paper and used as pressure clamps tightened with screws or bolts to firmly attach the paper to the board.

### BRIEF SUMMARY OF THE INVENTION

Unlike commonly used methods of adhesion and tightened mechanical clamping, this watercolor paper stretcher and holder device holds watercolor paper taut against a board by means of strips of channel edging that are slid onto the edges of the board that is overlain with a piece of wet watercolor paper wrapped around the board edges and onto the board back. Friction of the channel edging strips against the paper and the wrapping of the paper around the board keep the paper from buckling and moving during initial drying on the board and during rewetting with aqueous media in the process of painting.

### BRIEF DESCRIPTION OF THE SEVERAL VIEWS OF THE DRAWING

FIG. 1 is a perspective view of the board and the channel edging strips.

FIG. 2 is a perspective view of a channel edging strip showing its form.

FIG. 3 is a cross-section view of the board and a channel edging strip.

FIG. 4 is a perspective view of paper laid onto the face of the board.

FIG. 5 is a cross-section view of the board wrapped with paper and a channel edging strip.

FIG. 6 is a cross-section view of the board wrapped with paper fully seated into a channel edging strip.

FIG. 7 is perspective view of the invention completely assembled, with channel edging strips holding paper onto the board

### DETAILED DESCRIPTION OF THE INVENTION

Watercolor paintings executed on watercolor paper are difficult to create if the paper buckles or wrinkles substantially during the painting process. For this reason, watercolor paper is most often stretched and secured to a rigid board. If watercolor paper is secured to a rigid board without first being stretched, it will buckle and wrinkle during wetting in the process of painting. Typically, watercolor paper is stretched by first wetting the paper by soaking it until the fibers absorb as much water as they are able to do and then securing it to a board. A common securing method is taping the wet paper to a board that is several inches larger in area than that of the piece of paper. This is typically done with gummed paper or package tape of 2 or more inches in width, about half of which width is placed onto the paper at its edge and half is placed onto the front face of the board. Often this method is unsatisfactory because the tape becomes detached from the watercolor paper or the board when rewetted during the execution of the painting. Many of the boards are of wood finished with a waterproof coating such as polyurethane to which gummed tape does not adhere well, especially upon repeated rewetting during painting. Another common method for securing the paper to the board is stapling through the wet paper into a wood board. With this method, often the paper tears as it pulls away from the staples during drying. Too, at the completion of the painting removing the paper from the board often involves use of sharp or bladed tools to pry out the staples, so is both tedious in general and risky in the possibility of tearing or marring the painting. Stapling and removing staples also leaves the board surface roughened and abused, so that subsequent attachments of watercolor paper to the board are made more difficult, and the waterproof coating is more and more compromised by the perforations through it made by the staples. Another method for securing watercolor paper to board is clamping the paper to the face or edge of the board with metal, wood, plastic or other devices that are tightened by means of screws or bolts. Typically these devices are time consuming in the operation of attaching the paper. Too, many of them require the use of tools for tightening fasteners, so that such tools must be available for attaching, removing or adjusting the paper. Additionally, many of these devices are of designs that add dimensionally to the height or width or thickness of the board with screw heads, rails, clamps and such that are cumbersome and difficult to manage during the execution of the painting.

The following describes a watercolor paper stretcher and holder device that is easy to apply and remove, requires no tools to do so, adds little to the dimensions of the board at face, back or edges, and is completely effective in maintaining a taut, flat surface of the watercolor paper during the wetting and rewetting process of painting execution.

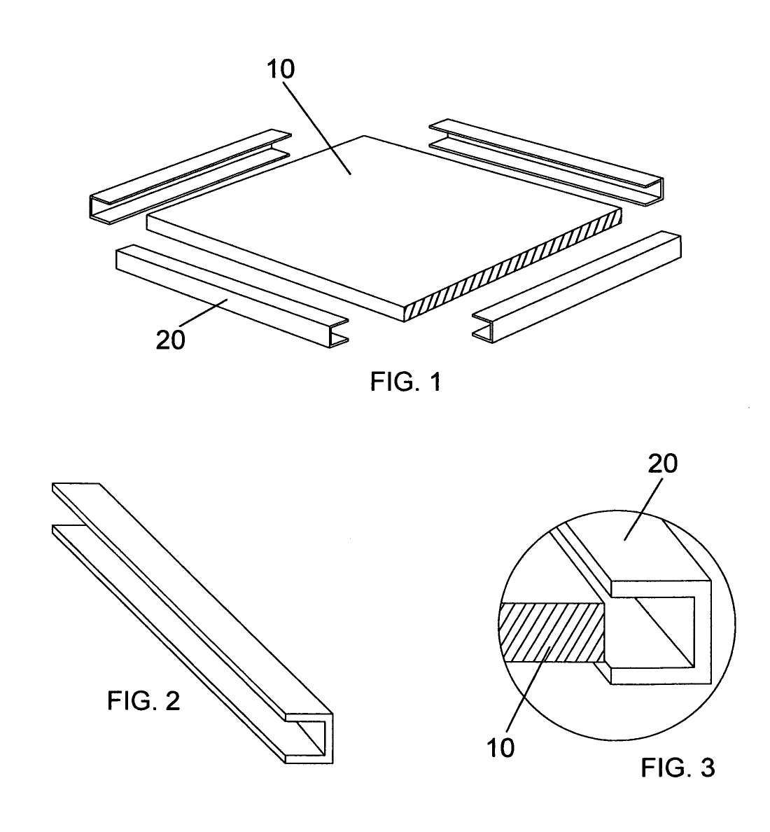

The device is comprised of a rigid board 10 and pieces of channel edging 20 as shown in FIG. 1. The board 10 is composed of wood or other material made waterproof by polyurethane or other finishing, or plastic, or tempered hardboard or other waterproof or waterproofed material. It is of dimensions of height and width smaller than the dimensions of industry standard watercolor paper, or industry standard watercolor paper halved, as paintings are frequently executed on half sheets. Its depth (thickness) is such that the board is rigid. The channel edging pieces 20 are composed of plastic, vinyl, metal or other non-porous material, fabricated so that they are of three faces angled from one to another so that they form an open channel along their entire lengths as shown in FIG. 2. The open channel may be the same size as the opposite face of the edging, or it may be narrower so that it is a smaller opening than the size of the opposite face of the edging. The channel edging pieces are of lengths shorter than the dimensions of the board height and width as shown in FIG. 1, and of channel opening size slightly larger than the depth (thickness) of the board, as shown in FIG. 3. The preferred material of their composition is plastic or vinyl, but metals may also be used.

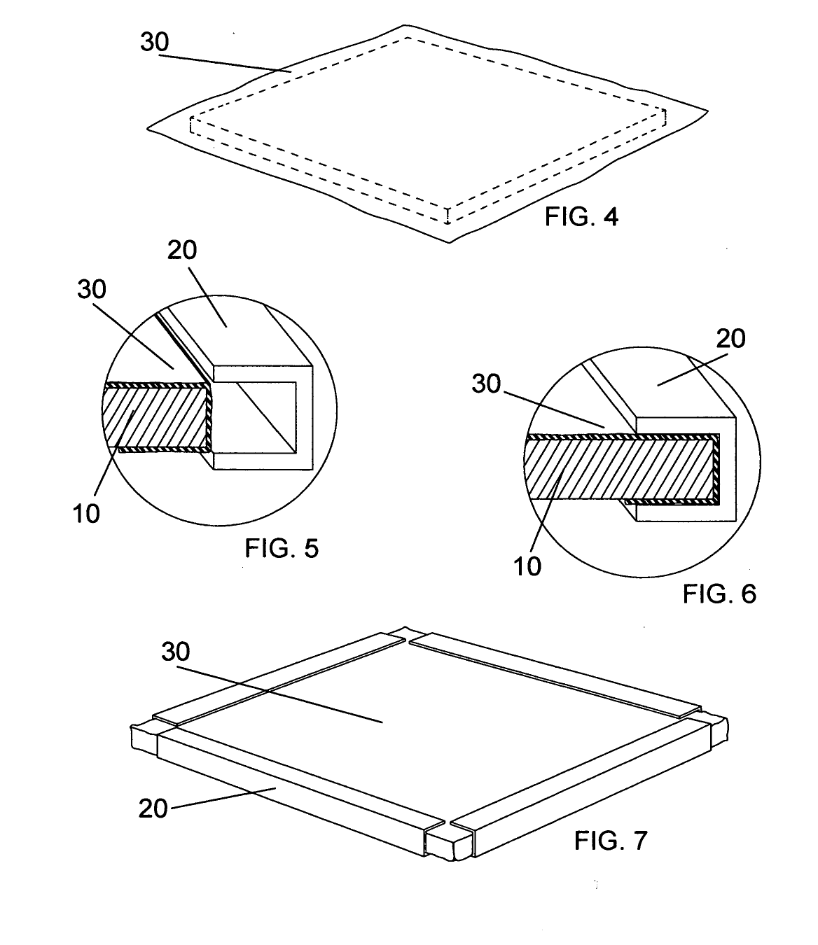

In use, watercolor paper 30 first soaked in water is then laid onto the face (length and width) of the board 10 so that paper extends beyond each board edge as shown in FIG. 4. The wet paper is then wrapped around each edge of the board and onto the back face of the board as shown in FIG. 5. A piece of channel edging 20 is placed so that its open channel faces the paper-wrapped board edge as shown in FIG. 5, then pressed against the paper-wrapped board edge as far as it is able to be pressed until it sits securely as shown in FIG. 6. Other pieces of channel edging 20 are then likewise pressed onto the paper-wrapped board edges so that the paper is secured to the board all around as shown in FIG. 7. The painting process can then begin while the paper is yet wet, or can begin after the paper has dried. After completion of the painting, the channel edging pieces can be removed by pulling them away from the paper-wrapped board edges.

What is claimed is:

1. A watercolor paper constraining stretcher and holder comprised of a rigid base board and channel edging pieces, the channel openings of which are of slightly greater in size than the board depth (thickness).

2. A watercolor paper constraining stretcher and holder comprised of a rigid base board and channel edging pieces such that when the channel edging pieces are pressed onto the edges of the board once wrapped with watercolor paper the paper is securely held to the board.
